(19) United States
(12) Patent Application Publication
(10) Pub. No.: US 2008/0232269 A1
(43) Pub. Date: Sep. 25, 2008

(54) DATA COLLECTION SYSTEM AND METHOD FOR IP NETWORKS

(76) Inventors: LANCE A. TATMAN, Granite Bay, CA (US); Slawomir K. Ilnicki, Los Altos Hills, CA (US); Glen L. Purdy, Snohomish, WA (US)

Correspondence Address: AGILENT TECHNOLOGIES INC., INTELLECTUAL PROPERTY ADMINISTRATION,LEGAL DEPT., MS BLDG. E P.O. BOX 7599, LOVELAND, CO, 80537, US

(21) Appl. No.: 12/053,021

(22) Filed: Mar. 21, 2008

Related U.S. Application Data
(60) Provisional application No. 60/896,767, filed on Mar. 23, 2007.

(51) Int. Cl. G06F 11/00

(52) U.S. Cl. 370/252

(57) ABSTRACT

A system operative to collect and analyze data in a digital network includes a probe layer comprising a probe disposed in the digital work. The probe is configured to identify and capture data from frames passing through the probe. The system also includes an analysis layer operative to receive the captured data from the probe. In addition, the system includes an application layer comprising a system master operative to mediate between an application and the probe.

### CROSS-REFERENCE TO RELATED APPLICATIONS

The present application claims priority under 35 U.S.C. § 119(e) from commonly owned U.S. Provisional Patent Application 60/896,767 (Atty. Docket No. 10070191-1) filed on Mar. 23, 2007 and entitled “DATA COLLECTION SYSTEM AND METHOD FOR IP NETWORKS.” The entire disclosure of this cross-referenced provisional patent application is specifically incorporated herein by reference.

### BACKGROUND

As digital networks are called upon to carry more traffic, and newer kinds of traffic, network operators and service providers are called upon to diagnose and validate these networks. Diagnosis and validation are based upon measurements.

Network devices, such as switches and routers already deployed in the field, may have measurement capability built in. But while some measurements may be available, there is usually little flexibility in that capability. As new services are deployed across networks, new measurements must be made, often times examining aspects of network operation that were not significant before. As examples, new types of measurements include VoIP, IMS and PTT measurements, Video QoS measurements, and IP flow based measurements. Often, these measurements are best made at the edges of the network, closest to the customers.

To make these measurements, new measurement equipment, often in the form of probes, must be deployed through the network, or old equipment upgraded. Upgrading, if possible, is expensive. New probe deployment is also expensive, not only in terms of labor and equipment, but also in finding space and power in typically cramped networking environments to locate the new probes. Most systems will have many probes making many measurements distributed across various switches. This measurement data is typically transmitted to central systems for aggregation and analysis. Multiple probes making multiple measurements typically result in multiple systems each performing a specific analysis task. Because of the high costs involved with such systems, it is not economically feasible to take measurements in a ubiquitous nature, or at the edges of the network where large numbers of probes would be required.

What is needed, therefore, are a method and system that overcomes at least the drawbacks of known techniques and systems described above.

### Defined Terminology

It is to be understood that the terminology used herein is for purposes of describing particular embodiments only, and is not intended to be limiting.

As used in the specification and appended claims, the terms ‘a’, ‘an’ and ‘the’ include both singular and plural referents, unless the context clearly dictates otherwise. Thus, for example, ‘a device’ includes one device and plural devices.

### BRIEF DESCRIPTION OF THE DRAWINGS

The present teachings are best understood from the following detailed description when read with the accompanying drawing figures. The features are not necessarily drawn to scale. Wherever practical, like reference numerals refer to like features.

FIG. 1 shows an overview of a monitoring platform in accordance with a representative embodiment.

FIG. 2 is a conceptual representation of an optical probe 200 in accordance with a representative embodiment.

FIG. 3 shows conceptual representations of data packets in accordance with a representative embodiment.

FIG. 4 shows simplified block a network measurement system in accordance with a representative embodiment.

FIG. 5 shows a hierarchical view of a network measurement system in accordance with a representative embodiment.

FIG. 6 shows an example network in accordance with a representative embodiment.

FIG. 7 shows a second example network in accordance with a representative embodiment.

### DETAILED DESCRIPTION

In the following detailed description, for purposes of explanation and not limitation, representative embodiments disclosing specific details are set forth in order to provide a thorough understanding of the present teachings. Descriptions of known systems, software, hardware, firmware and methods of operation may be omitted so as to avoid obscuring the description of the example embodiments. Nonetheless, systems, software, hardware, firmware and methods of operation that are within the purview of one of ordinary skill in the art may be used in accordance with the representative embodiments.

In general, embodiments of the present teachings relate to a system and method for data collection and probe management on IP networks. Existing network infrastructure devices such as switches and routers use pluggable components known as interface converters which convert signals from optical or electrical form to the electrical signaling levels used internally in the network infrastructure device. These interface converters are standardized, and come in form factors including but not limited to as XPAK, XENPAK, GBIC, XFP, and SFP.

According to an aspect of the present teachings, existing interface converters in a network are replaced with smart interface modules (also referred to herein as probes), which provide probe functionality without increasing equipment footprint. Additional embodiments may place the probe functionality directly on the switch or router line card instead of on a modular interface converter. It should be appreciated that in such embodiments, the switch or router line card, in essence, becomes a probe. Probes may be configured, either prior to installation or remotely, to collect data on the fly from packet traffic.

Various software components support the operation of probes. Analyzers collect measurement data from sets of probes and provide storage, data transformation, and analysis. Probe managers manage sets of probes, tracking probe state, updating probe configurations, and collecting configuration command responses and topology information from probes. The System Master may collect topology and probe resource information from the Probe Managers and act as an intermediary between applications and Probe Managers. For example, configuration data may be sent by a Probe Manager connected to the network.

The System Master may also assist in allocating probe resources to applications and to mediate between multiple applications and multiple analyzers. Moreover, the System Master may control a plurality of smart interface modules (probes). Application servers host applications that make use of collected data. Applications and applications servers communicate with Analyzers and the System Master via an open API.

Notably, not all software components need to be present in a system; while components may be geographically diverse, they may also reside on the same hardware.

One embodiment of communications to and from smart interface converters is described in detail in U.S. Pat. No. 7,336,673, entitled “A Method of Creating a Low-Bandwidth Channel within a Packet Stream,” the entire disclosure of which is hereby specifically incorporated by reference. Aspects of smart interface converters are described, for example, in “Assisted Port Monitoring with Distributed Filtering,” application Ser. No. 10/407,719, filed Apr. 4, 2003, “Passive Measurement Platform,” application Ser. No. 10/407,517 filed Apr. 4, 2003, and “Automatic Link Commissioning,” application Ser. No. 11/479,196, filed Jun. 29, 2006. The entire disclosures of each of these patent applications are also specifically incorporated herein by reference.

One known form factor of interface converter known as a GBIC converts signals from optical to electrical form; optical signals carried on fiber optic cables being used to communicate over the network, and electrical signals being used within the device housing the GBIC. Other GBIC forms convert signals from twisted-pair copper conductors used in high-speed networks to electrical signals suitable for the device housing the GBIC. While the present teachings are described in terms of the GBIC form factor, it is equally applicable to other form factors including but not limited to XPAK, XENPAK, XFP, SFP or chipsets on a router/switch linecard. In addition to the high-speed interfaces, interface converters may contain a slow-speed data port which may be used for configuration, testing, and sensing device status according to standards such as SFF-8742.

Smart interface converters deployed as probes include additional logic within the interface converter package. This additional logic may include the ability to query the status of the interface converter, perform internal tests, and/or perform data capture and analysis. The smart interface converter also adds the ability to inject data packets into the high speed data stream. In conjunction with such communications capability, the smart interface converter contains a unique identifier, such as a serial number or a MAC address. As deployed according to the present teachings, smart interface converters are used as probes. These probes may be configured remotely to collect data based on network traffic, and send that collected data to multiple locations for processing. The low cost of the probes and remote configurability allows them to be placed at the edges of networks.

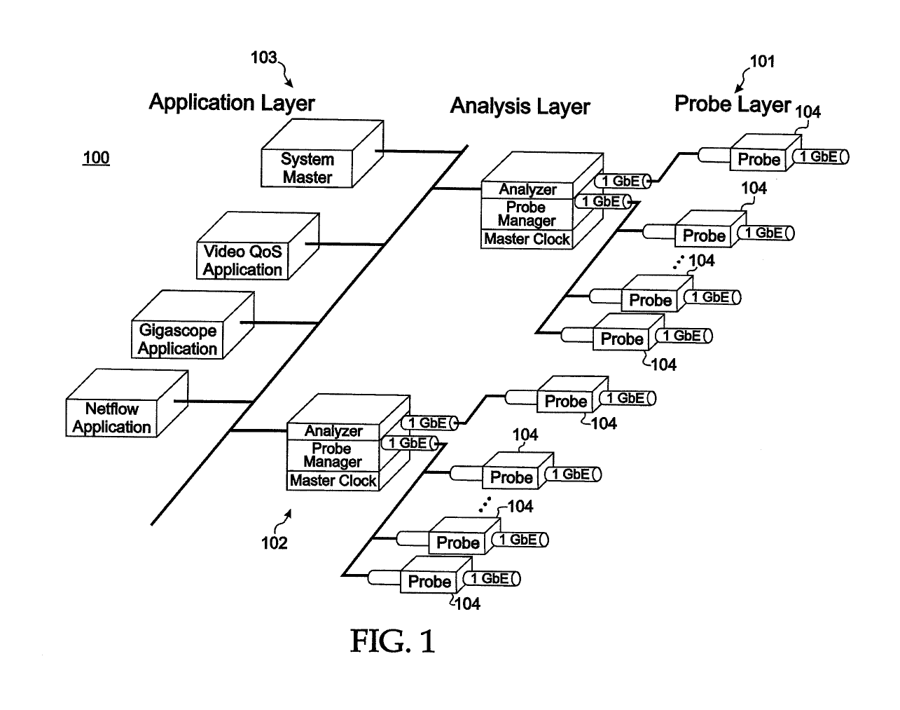

FIG. 1 is a simplified overview of a monitoring system 100 in accordance with a representative embodiment. The system 100 comprises three ‘layers’ instantiated in hardware and software. The layers include a probe layer 101, analysis layer 102 and an application layer 103.

In a representative embodiment, the probe layer 101 comprises a plurality of probes 104 illustratively in GBIC form factor pluggable transceivers. As noted above, the probes 104 may also be referred to herein smart interface modules. The probes 104 are used in place of the pluggable modules often used in known router and switch line cards. Notably, the probes are dynamically configurable. In representative embodiments the probes are configured indirectly by applications.

The analysis layer 102 provides flow management and time synchronization, among other functions, and includes an Analyzer, a Probe Manager and a Master Clock. The probes 104 of probe layer 101 are divided into groups, with each group being managed by a probe manager. The probe manager works with the System Master in an application layer 103 to orchestrate measurement requests from various applications. The analysis layer 102 is adapted to provide a time synchronization master, such as an IEEE 1588 synchronization master. Each master maintains synchronization of entire groups of probes with each probe functioning as an IEEE 1588 slave. The analysis layer 102 also collects data from the probes of the probe layer and formats and forwards these data to the appropriate suite of the application layer 103.

Among many other functions, the analysis layer 102 also handles multiple common requests from the application layer 103. For example, if both a video and audio applications require the same data, the analysis layer 102 garners these data from the probe layer 101 and replicates the data (in this case twice) and provides the data to the requesting applications.

The application layer 103 includes the system master that acts as an arbiter between applications requesting measurements and ensuring that measurements requests are executed within the specified parameters. Among many other functions, the system master of the application layer 103 may be adapted to function as a licensing manager. For instance, the probes of the probe layer 101 may require a license to function in the system. The system master may be required to verify the license before authenticating a probe. The application layer of the representative embodiment shows three representative applications: Video QoS; Gigascope; and Netflow. These are merely illustrative and it is emphasized that more or fewer applications may be included. Such applications are within the purview of one of ordinary skill in the art.

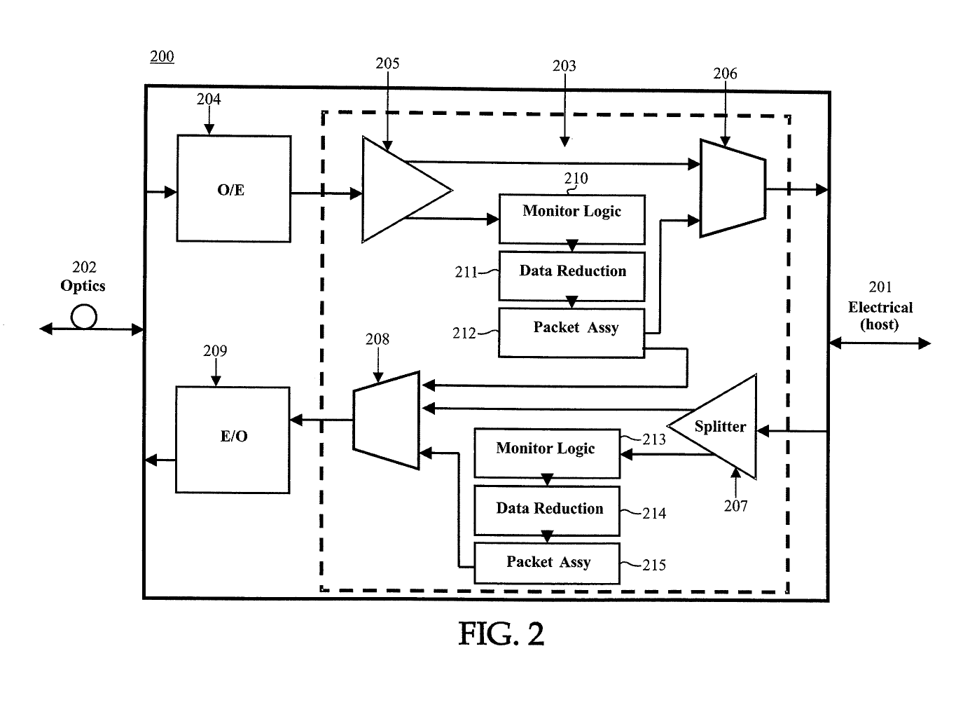

FIG. 2 is a conceptual view of an optical probe 200 in accordance with a representative embodiment. The optical probe 200 may be one of a plurality of probes found in probe layer 101 of the system 100 described above. Detailed descriptions of probe 200 may be found in the above-referenced patent application having application Ser. No. 10/407,719 and entitled “Assisted Port Monitoring with Distributed Filtering.” The probe 200 has an electrical interface 201 on the line card side of the probe and an optical or electrical interface on the network side of the probe.

The embodiment shown in FIG. 2 is for a probe with an optical interface on the network side. Other embodiments are contemplated. The probe 200 comprises an optical-to-electrical converter 204, which converts the optical signal to an electrical signal, and provides the electrical signal to a chip 203. The chip 203 may be an application specific integrated circuit (ASIC) or a programmable logic device such as a field programmable gate array (FPGA) or other similar technology which provides the same functionality. The chip 203 is configured with a splitter 205, which provides an output to a sequence of monitor logic 210, data reduction 211 and packet assembly 212; and to a combiner 206. The output of the packet assembly is provided to the combiner 206.

Electrical data at the electrical interface 201 are received at the chip 203 at another splitter 207, which provides an output to sequence of monitor logic 213, data reduction 214 and packet assembly 215; and to a combiner 208. The combiner then provides the signal to an optical to electrical converter 209 that provides the data to the optical interface 202.

Normal traffic flows into the chip 203 via the optical interface 202 when it enters to the chip. The normal traffic passes through splitter 205 with one path allowing it to continue on through the combiner 206 where it is forwarded out the electrical interface 201. In parallel, on the other path from splitter 205, a copy of each frame is sent through the monitor (or probe) logic 210 where it is compared to user defined filters. If there is a match, then one or more of the following may happen: a counter may be incremented; a copy of the frame may be made; or some part of the frame may be extracted. At some point there will be results data generated from the above actions that will need to be sent out, the probe will insert the results frames, addressed to an analyzer, into the normal traffic flow using a subchannel as described in U.S. Pat. No. 7,336,673.

A slow-speed interface such as the 12C may be used, for example, to configure a parameter memory during manufacturing, and prior to device deployment. A device serial number may be stored in parameter memory. Parameter memory may also preset the destination address for collected data including test information. This address, by example, may be an IPV4 or IPV6 address. Additionally, configuration of many of these parameters may be performed over the network.

As used according to the present teachings, filter configurations are stored in parameter memory, either prior to device deployment, or while deployed in the field. These filter configurations define the frames and data within those frames that is to be captured. Captured data may be time-stamped, and/or accumulated. Entire frames may be captured, or only a portion of a frame, for example the first 64 bytes, or only the source and destination IP addresses. Captured data are stored in extra packet memory. Using the capability to then inject data stored in extra packet memory into the high speed data stream, this data may be sent to a destination address for analysis. Multiple filters may be active at one time, and each filter may have its own destination address. Commands and new filter configurations may be sent to probes, individually, for example using the serial number stored in each probe, or in groups. Commands and new filter configurations may be authenticated by probes, as an example by verifying message checksums, or by verifying authentication codes passed to the probes.

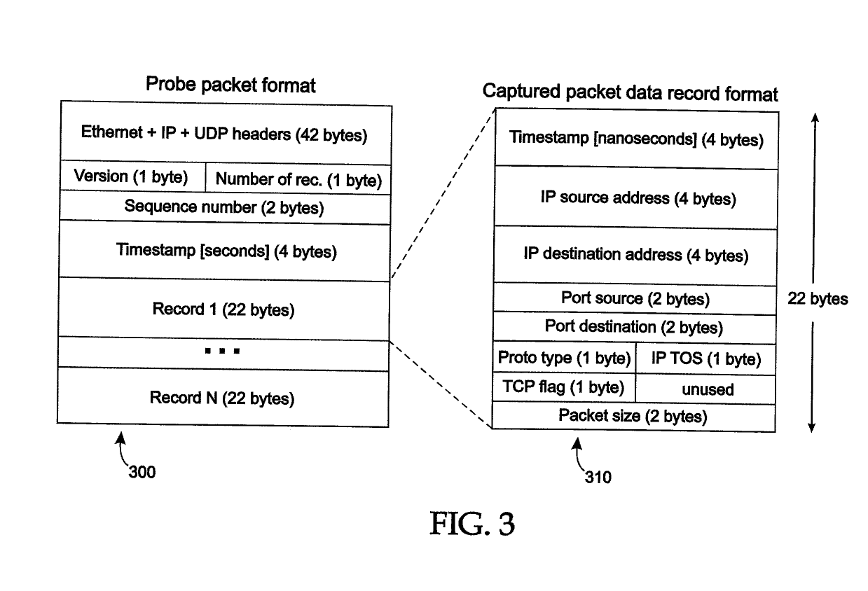

When only portions of a frame are needed, captured data may be aggregated in the probe. Aggregated data is stored in extra packet memory. Probe and capture packet formats suitable for use in accordance with the present teachings are shown in FIG. 3. An example captured packet data record is shown as 310. Multiple records may be aggregated into probe packet 300. The number of such records depends on the size of an extra packet memory (not shown), and the desired Ethernet frame size. Using the embodiment of FIG. 3 as an example, a typical Ethernet frame could contain 66 records. Probe packet 300 contains the usual Ethernet header, plus a timestamp in seconds. If these probe packets are transmitted at least once per second, the captured packet data records 310 need only carry the fractional seconds portion of the time; nanosecond resolution is possible. Captured packet data record 310 contains information needed for further analysis, such as the timestamp, IP source and destination addresses, source and destination ports, flags, and the size of the original packet from which this data was gleaned. The information stored in the captured packet data record will vary according to the analysis required. The example given is for a simple IP flow analysis.

Probes 104 may also be adapted to intercept and respond to timing frames according to the IEEE-1588 standard, acting as an IEEE-1588 slave. In the embodiment of FIG. 1, real-time clock information may be kept by the Master Clock, which may be a IEEE 1588 master clock in analysis layer 102 Beneficially, the probes of the representative embodiments adapted to function as IEEE 1588 slaves may provide, among other functions accurate time-stamping.

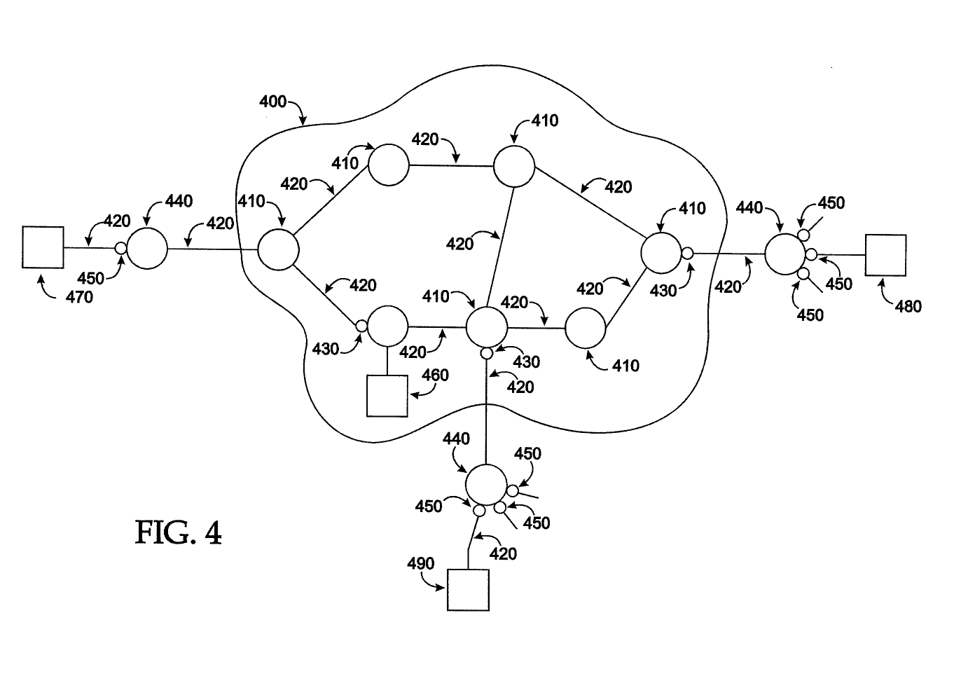

FIG. 4 shows a network measurement system according to a representative embodiment. System 470 streams data through links 420 and network 400 to system 480. Network 400 contains switching elements 410 interconnected through connections 420. According to the present teachings, some of these connections 420 terminate at switching elements 410 using smart interface converters 430 used as probes. External to network 400, with switching elements 440 contain connections 420 some of which terminate using smart interface converters 450 used as probes. System 460 inside network 400 hosts an IEEE 1588 master clock, Probe Manager, Analyzer server and other software components for probes 430 inside network 400. Similarly, system 490 hosts an IEEE 1588 master clock, Probe Manager, Analyzer server and other software components for probes 450 outside network 400. For this example, system 490 also hosts the System Master, and the application software components.

In an example using the well known Netflow protocol to collect data to classify network traffic between systems 470 and 480, the System Master component queries the Probe Manager component (both running on system 490), allocating and configuring the appropriate probes 450 connecting systems 470 and 480 to make the desired measurements and send the aggregated data to the Analyzer component running on system 490. The Analyzer component running on System 490 processes records, as an example in the form shown in FIG. 3, expanding them to Netflow records and passing them to the Netflow application. Collecting the data on the probes and performing the required processing to convert captured data in the form of FIG. 3 to Netflow records in the Analyzer component instead of collecting and sending the data out natively on switching elements 410 and or 440 greatly reduces the computation demand placed on switching elements 410 and or 440.

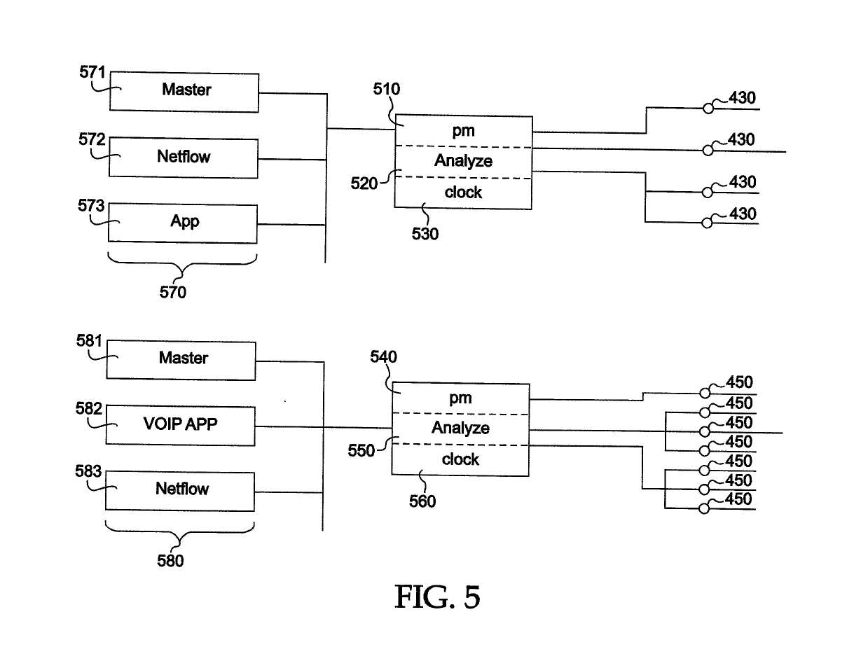

FIG. 5 shows the network of FIG. 4 in a hierarchical fashion. Probes 430 communicate with Probe Manager 510 and Analyzer component 520. IEEE-1588 Master clock 530 may be present to synchronize timekeeping across systems and probes, the probes themselves are functional as IEEE 1588 slaves. These components may be present in one physical system as shown, or they may be distributed. Similarly, applications suite 570, which comprises a System Master 571, a Netflow Manager 572 and Application Components 573 may be co-resident on one physical system, or may be distributed.

Similarly, probes 450 in FIGS. 4 and 5 communicate with Probe Manager 540 of FIG. 5, Analyzer 550, and have timing information supplied by IEEE-1588 clock 560. These components communicate with applications suite 580, which includes Master 581, VoIP Application Components 582 and Netflow Application 583.

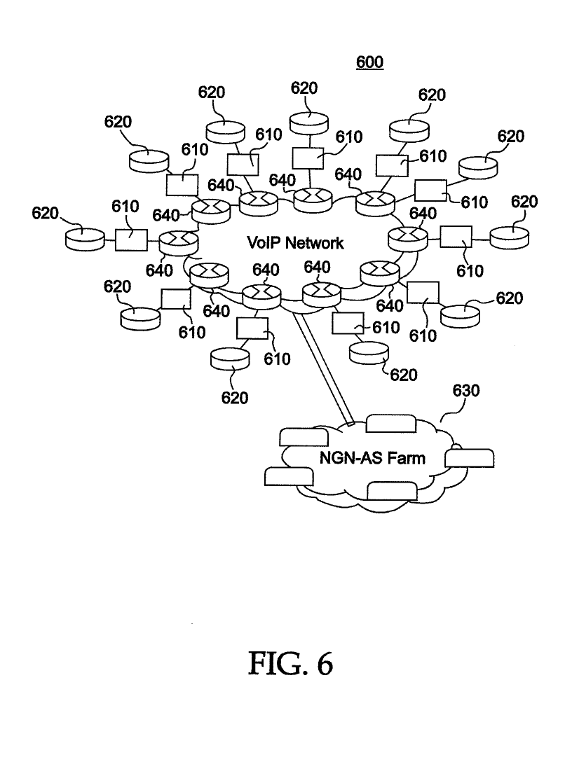

As examples of network measurement, FIG. 6 shows a representative embodiment, which may be used for remote collection of quality measurements for Voice over IP (VoIP), IP Multimedia (IMS), and Push to Talk Signaling (PTT) in a VoIP network 600. Service providers install smart interface modules for use as probes 610 wherever measurements of VoIP/IMS/PTT are desired, typically between customer proxy 620 and edge proxy 640. Probes 610 are managed and configured to begin collecting, for example, VoIP signaling data.

In most cases, these probes 610 completely replace the existing probe, reducing instrumentation costs, and saving space and power. It will also eliminate the need for a mirror port and consequently, port replicators, again reducing instrumentation costs. Because probes 610 are limited in memory and computation power, they are not used for many computations except possibly some counters. Instead, copies of the signaling data are made from each signaling frame and time-stamped. These copies of the signaling data or “results frames” are then sent for analysis to the signaling analysis farm 630. The “farm” of signaling analysis servers will serve multiple probes and the probes may serve multiple applications

There are two main aspects of measuring VoIP: call signaling and call quality. For call signaling, service providers may typically use SIP (Session Initiation Protocol). To monitor call signaling nearly the entire packet must be captured and delivered to the monitoring application 630. Therefore, the probes 610 will capture SIP signaling packets as they cross for example between the customer proxy 620 and the edge proxy 640, and send them to “farm” 630 for analysis. Voice quality monitoring may require capturing only certain data from packet headers. Because the prevalent transport protocol used for VoIP is RTP/UDP, this means that capturing and time-stamping information from protocol headers such as RTP may be sufficient to assess voice quality.

Data associated with addressing, for instance, IP addresses and transport layer ports should be captured as well. There may be a single application that monitors both voice quality and signaling or there may be a separate application for each. In either case, a closed loop will enable the system to only monitor the desired calls. For instance, if a provider wants to monitor calls from customer A. It can set a filter to look for SIP signaling protocol messages coming from customer A. When SIP signaling from customer A is captured, the monitoring application could then notify the System Master to configure a filter to monitor the application port indicated in the SIP signaling message. That filter will then cause the actual call to be replicated and sent to the monitoring application for analysis. While the primary use of this would be for quality monitoring, it is easy to see how it could be adapted to other uses, such as enforcement of a wire tap order.

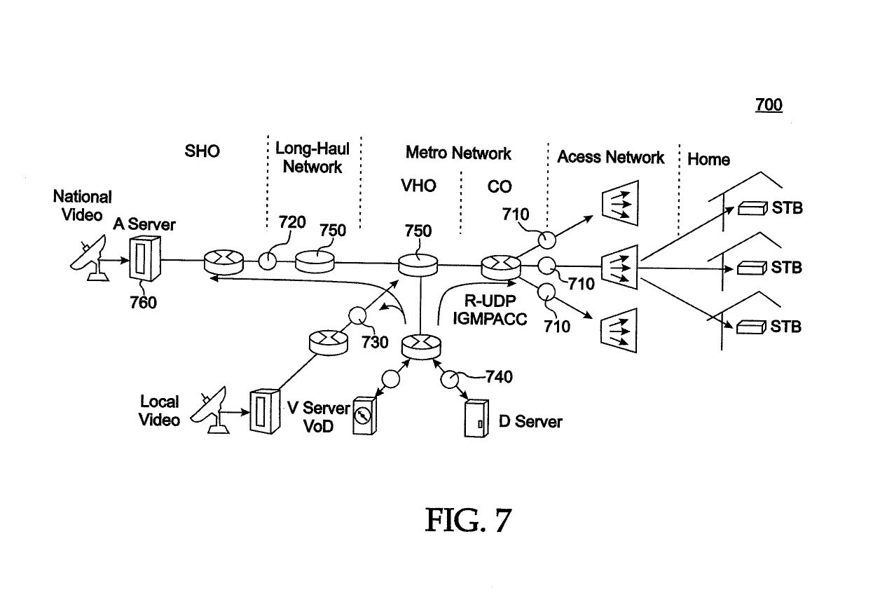

As an additional example shown in FIG. 7, a representative embodiment may be used for remote collection of video quality of service (QoS) measurements for Video over IP such as IPTV and Video on Demand (VoD) networks. Information so collected can also be used for troubleshooting and/or diagnostics in these networks.

In order to compete with the other delivery vehicles, the quality of these video over IP services must be as good as or better than that of the alternatives available to consumers. Therefore, having a means to measure video quality is imperative. Current modes of measurement will not scale economically to where they can be deployed at the edges of the network nearest the customer, which leaves Service Providers making measurements in less than ideal locations and in fewer locations than they would like. Ideally, the Service Providers can make measurements as close to the customer as possible, at any time, for any customer, on any video stream.

FIG. 7 illustrates an example network 700, using the technology referenced above, in this example, using probes in the SFP form factor commonly used in DSLAM equipment, the service provider would deploy the modules on all interfaces at the DSLAM. In addition, they would deploy the modules as close as possible to the video encoder.

The modules at the DSLAM (measurement point 710 on Access Network are configured to collect various information used to measure Video QoS. In this example, the transport headers (packet references) are collected and time-stamped for every video stream and sent up to an application, such as Agilent's Triple Play Analyzer (TPA) product for analysis. At the same time, probes close to the video encoder or server that multicast video streams such as server 760 collect a richer set of information (measurement point 720 or 730). This may be a time-stamped copy of the entire video stream along with all signaling data. This information is sent to an application, again, such as Agilent's TPA, for analysis. If a problem is detected near the DSLAM, the data collected at the DSLAM can be compared to the data collected nearest the server, for instance, the D Server, may even help in recovering missing video frames (measurement point 740) and determine if the data was corrupted in transit or if the data was corrupt right out of the head end server such as A Server 760. Using data references from measurement points 710 and full video streams collected at measurement points 720 or 730, the application can determine the video QoS or video QoE (Quality of Experience) by looking for example at what type of video frames were lost. Other examples like this can be given. A long list of video quality measurements may be provided. Also, various measurements may be taken depending on the type of video distribution in use. For example, in a system using Microsoft IPTV Edition, measurements with respect to Reliable UDP will be important. By measuring activity such as Reliable UDP which is used by Set-Top Boxes (STB) to recover missing packets from the D Server the problem could be traced to the last mile without having monitoring equipment present at customer premises.

In one aspect, the representative embodiment the collection of data from various vantage points and correlation allows for the detection of problems or measurement of video quality close to the customer. From certain data acquisition points like 710 in the above figure time-stamped references of video packets are collected and by doing so the measurement traffic from this point is reduced by an order of magnitude. In this example, using SFP modules as opposed to an external box, we are able to make measurements closer to the edge of the network in an economically scaleable way. In addition, because the DSLAMS need to use SFP modules anyway, there is zero additional installation cost and no additional space or power are required to make the measurements.

While the embodiments of the present teachings have been illustrated in detail, it should be apparent that modifications and adaptations to these embodiments may occur to one skilled in the art without departing from the scope of the present teachings as set forth in the following claims.

1. A method of collecting and analyzing data in a digital network, the method comprising:
installing smart interface modules in a plurality of locations in the digital network,
configuring the smart interface modules to identify and capture data from frames passing through the smart interface module,
configuring the smart interface module to transmit the captured data through the digital network to an analysis layer,
collecting the transmitted data at the analysis layer,
analyzing the data at the analysis layer, and forwarding the data to an application layer.

2. A method as claimed in claim 1, wherein transmitting captured data further includes aggregating the captured data prior to transmission.

3. A method as claimed in claim 1, wherein the configuration of the smart interface module is performed prior to installation.

4. A method as claimed in claim 1, wherein the configuration of the smart interface module is modified by configuration data sent through the network.

5. A method as claimed in claim 4, where the configuration data sent through the network modifies the configuration of a single smart interface module.

6. A method as claimed in claim 4, where the configuration data sent through the network modify the configuration of a plurality of smart interface modules.

7. A method as claimed in claim 4, wherein the configuration data are sent by a probe manager connected to the network.

8. A method as claimed in claim 1, wherein a probe manager controls a plurality of smart interface modules.

9. A method as claimed in claim 4, wherein the configuration data are sent by a system master connected to the network.

10. A method as claimed in claim 1, wherein a system master controls a plurality of smart interface modules.

11. A method as claimed in claim 1, wherein the smart interface modules are substantially synchronized.

12. A method as claimed in claim 1, further comprising mediating between multiple applications and multiple smart interface modules.

13. A system operative to collect and analyze data in a digital network, comprising:
a probe disposed in the digital network, wherein the probe is configured to identify and capture data from frames passing through the probe, and to transmit the captured data to an analysis layer.

14. A system as claimed in claim 13, further comprising a linecard, which comprises the probe.

15. A system as claimed in claim 14, further comprising a system master operative to mediate between multiple applications and multiple probes.

16. A system as claimed in claim 13, further comprising a system master is operative to mediate between multiple applications and multiple analyzers.

17. A system as claimed in claim 13, further comprising a system master is operative to mediate between multiple applications and multiple probe managers.

18. A system as claimed in claim 13, further comprising an IEEE_{—}1588 master clock.

19. A system as claims in claim 13, wherein the probe acts as an IEEE_{—}1588 time synchronization slave.

20. A system as claimed in claim 13, wherein the system master maintains topology information.

21. A system as claimed in claim 13, wherein the system master maintains probe status information.

22. A system as claimed in claim 13, wherein the probes are adapted to send data to an analysis layer for forwarding to a configured application.

23. A system as claimed in claim 13, wherein the apparatus is operative to perform one of more of: data for IP flow measurements, VoIP Signaling Analysis, Video QoS, and VoIP QoS measurements.

24. A system operative to collect and analyze data in a digital network, comprising:
a probe layer comprising a probe disposed in the digital network, wherein the probe is configured to identify and capture data from frames passing through the probe;
an analysis layer operative to receive the captured data from the probe; and
an application layer comprising a system master operative to mediate between an application and the probe.

25. A system as claimed in claim 24, analysis layer further comprises a probe manager.

26. A system as claimed in claim 24, wherein the probes act as IEEE_{—}1588 time synchronization slaves.
